(19) United States
(12) Patent Application Publication
(10) Pub. No.: US 2020/0074430 A1
(43) Pub. Date: Mar. 5, 2020

(54) DEVICE CONTROL SYSTEM AND DEVICE CONTROL METHOD

(71) Applicant: PANASONIC INTELLECTUAL PROPERTY MANAGEMENT CO., LTD., Osaka (JP)

(72) Inventor: Yuuji NAKAYAMA, Osaka (JP)

(21) Appl. No.: 16/551,226

(22) Filed: Aug. 26, 2019

(30) Foreign Application Priority Data
Aug. 29, 2018 (JP) 2018-160004

(51) Int. Cl. G06Q 20/12; H04L 29/08

(52) U.S. Cl. CPC G06Q 20/127; G06Q 20/342; H04L 67/125

(57) ABSTRACT

A device control system includes: an instruction device that controls operation of an electrical device which requires key information to operate; and a terminal device that communicates with the instruction device. The terminal device includes a terminal communicator that: receives, from the instruction device, identification information for identifying the electrical device; and transmits, to a server, the identification information and use request information indicating a request for using the electrical device. The instruction device includes: an instruction communicator that receives, from the server, the key information and use period information indicating an available time period of the electrical device; and an instruction controller that, when the key information and the use period information are received via the instruction communicator, activates the electrical device for the available time period indicated in the use period information.

### CROSS REFERENCE TO RELATED APPLICATION

This application claims the benefit of priority of Japanese Patent Application Number 2018-160004 filed on Aug. 29, 2018, the entire content of which is hereby incorporated by reference.

### BACKGROUND

### 1. Technical Field

The present disclosure relates to a device control system and a device control method, each of which controls an electrical device.

### 2. Description of the Related Art

Conventionally, there is a system including a device which is available only within an amount of money paid by a user (see Japanese Unexamined Patent Application Publication No. 6-74783, for example).

Japanese Unexamined Patent Application Publication No. 6-74783 discloses a system including a device that makes a predetermined device available by scanning an amount on a prepaid card and transmitting an instruction signal for a license, and makes the predetermined device unavailable by transmitting an instruction signal for disabling the predetermined device when the remaining amount of the prepaid card becomes lower than a fee for use.

### SUMMARY

The system disclosed in PTL 1, unfortunately, needs a device capable of scanning a prepaid card since a user uses the prepaid card to pay money.

The present disclosure provides a device control system, etc. that has a simplified configuration and can activate an electrical device for a desired time period.

A device control system according to an aspect of the present disclosure includes: an instruction device that controls operation of an electrical device which requires key information to operate; and a terminal device that communicates with the instruction device, in which the terminal device includes a terminal communicator that: receives, from the instruction device, identification information for identifying the electrical device; and transmits, to a server, the identification information and use request information indicating a request for using the electrical device, and the instruction device includes: an instruction communicator that receives, from the server, the key information and use period information indicating an available time period of the electrical device; and an instruction controller that, when the key information and the use period information are received via the instruction communicator, activates the electrical device for the available time period indicated in the use period information.

A device control method according to an aspect of the present disclosure is a device control method of controlling operation of an electrical device which requires key information to operate, the device control method including: by a terminal device, receiving, from an instruction device, identification information for identifying the electrical device, and transmitting, to a server, the identification information and use request information indicating a request for using the electrical device; and by the instruction device, when the key information and use period information indicating an available time period of the electrical device are received, activating the electrical device for the available time period indicated by the use period information received.

It should be noted that these generic or specific aspects may be implemented as a system, a method, an integrated circuit, a computer program, a computer-readable recording medium such as a CD-ROM, or any combination thereof.

A device control system, etc. according to an aspect of the present disclosure has a simplified configuration and can activate an electrical device for a desired time period.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is a perspective view for illustrating an overall configuration of a device control system according to an embodiment,

FIG. 2 is a block diagram showing a functional configuration of the device control system according to the embodiment,

FIG. 3 is a sequence diagram showing a processing procedure for making an electrical device available, which is performed by each device included in the device control system according to the embodiment;

FIG. 4 is a flow chart showing another exemplary processing procedure for making an electrical device available, which is performed by a terminal device and a server included in the device control system according to the embodiment;

FIG. 5 is a flow chart showing a processing procedure of when the terminal device included in the device control system according to the embodiment performs a process based on payment from a user;

FIG. 6A is a diagram showing the first example of an image displayed on the terminal device in use of the electrical device;

FIG. 6B is a diagram showing the second example of an image displayed on the terminal device in use of the electrical device;

FIG. 7 is a sequence diagram showing a processing procedure for changing usage conditions of the electrical device, which is performed by each device included in the device control system according to the embodiment;

FIG. 8 is a sequence diagram showing a processing procedure for changing the usage conditions to reduce power consumption of the electrical device, which is performed by each device included in the device control system according to the embodiment;

FIG. 9 is a sequence diagram showing, when the electrical device is a video display device, the first example of the processing procedure for making the electrical device available which is performed by each device included in the device control system according to the embodiment; and

FIG. 10 is a flow chart showing, when the electrical device is the video display device, the second example of a processing procedure for activating the video display device which is performed by an instruction device included in the device control system according to the embodiment.

### DETAILED DESCRIPTION OF THE EMBODIMENT

Hereinafter, embodiments of the present disclosure will be described with reference to the drawings. Note that the embodiments described below present a specific preferred example of the present disclosure. As such, the numerical values, shapes, materials, elements, the arrangement and connection of the elements, etc. presented in the following embodiments are examples and do not limit the present disclosure. Consequently, among the elements in the following embodiments, elements not recited in any one of the independent claims which indicate the broadest concepts of the present disclosure are described as arbitrary elements.

Note that the figures are schematic diagrams and are not necessarily precise illustrations. Additionally, elements that are essentially the same share like reference numerals in the figures, and overlapping explanations thereof are omitted or simplified.

### EMBODIMENT

### [Configuration]

### <Outline>

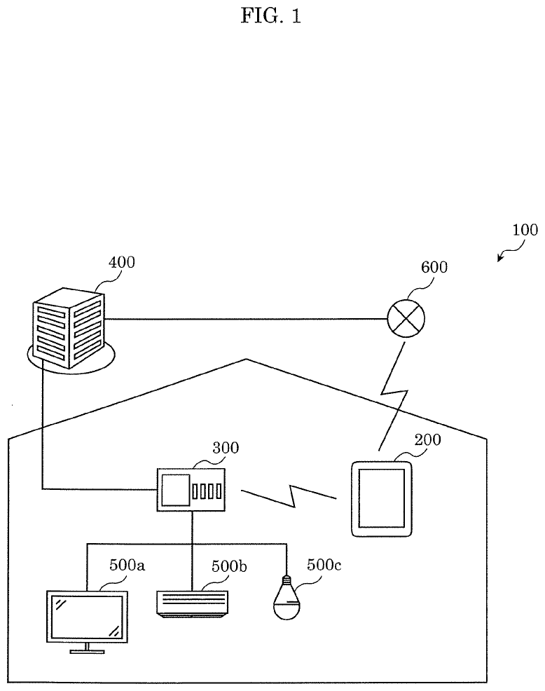

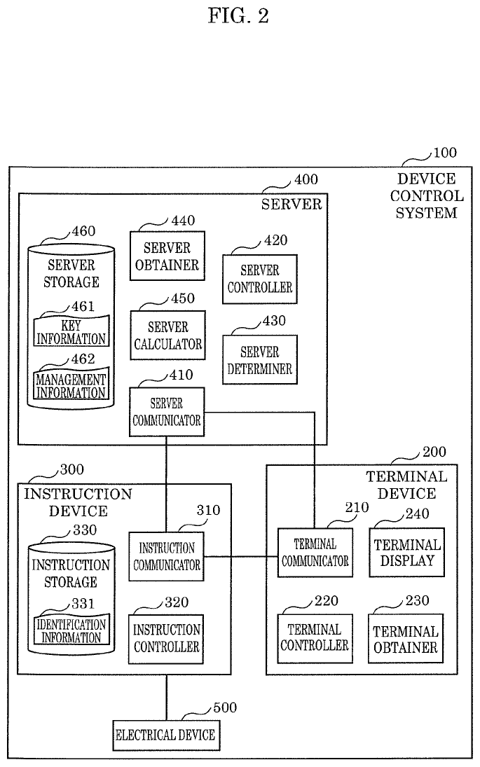

First, the configuration of a device control system according to an embodiment of the present disclosure will be described with reference to FIGS. 1 and 2.

FIG. 1 is a perspective view for illustrating an overall configuration of device control system 100 according to the embodiment. FIG. 2 is a block diagram showing a functional configuration of device control system 100 according to the embodiment.

Device control system 100 is a system for activating electrical device 500 for a predetermined time period. Device control system 100 controls electrical device 500 such as appliances in a house. Instruction device 300 included in device control system 100 can communicate with electrical device 500. Only when key information 461 for giving permission to activate electrical device 500 and use period information indicating an available time period of electrical device 500 are received from server 400 or terminal device 200, instruction device 300 controls electrical device 500 to cause electrical device 500 to perform a predetermined operation for the available time period indicated in the use period information. When instruction device 300 receives no key information 461, electrical device 500 cannot be freely operated by a user, for example, in such a manner that no power is supplied or no instruction on operation is accepted.

It should be noted that there may be one or two or more electrical devices 500 controlled by instruction device 300. In FIG. 2, the electrical devices controlled by instruction device 300 are collectively shown as electrical device 500. Furthermore, device control system 100 may include two or more terminal devices 200 and two or more instruction devices 300.

As a predetermined operation, for example, in the case where electrical device 500 is video display device 500a such as a television, only when instruction device 300 receives key information 461 and the use period information, a video is displayed for an available time period indicated in the use period information. Furthermore, for example, in the case where electrical device 500 is air conditioning device 500b as such an air conditioner, only when instruction device 300 receives key information 461 and the use period information, air is conditioned for a predetermined time period indicated in the use period information. Furthermore, for example, in the case where electrical device 500 is illumination device 500c, only when instruction device 300 receives key information 461 and the use period information, light is turned on for a predetermined time period indicated in the use period information. It should be noted that the predetermined time period may be set in advance to any value, and is not particularly limited. For example, the predetermined time period may be an hour, a day, or a month.

For example, only when key information 461 and the use period information are received, instruction device 300 makes electrical device 500 available by supplying power to electrical device 500 for an available time period. Here, the available time period means a time period during which electrical device 500 can be used. The available time period may be continuous period, or a total time of intermittent periods. When instruction information indicating an operation to be performed by electrical device 500 is received from terminal device 200, instruction device 300 causes electrical device 500 to operate based on the received instruction information. Furthermore, for example, when instruction information indicating an instruction to stop the operation being performed by electrical device 500 is received from terminal device 200, instruction device 300 causes electrical device 500 to stop the operation based on the received instruction information. Furthermore, for example, instruction device 300 measures a time period during which electrical device 500 is activated. For example, when the measured time period reaches the available time period indicated in the use period information, instruction device 300 stops supplying power to electrical device 500 to make electrical device 500 unavailable to a user.

For example, a user leases electrical device 500 from a management company of electrical device 500, and installs electrical device 500 in his/her house. When a user wants to use electrical device 500, the user pays an amount of money determined by the management company in advance, and operates terminal device 200 to receive key information 461 for making any electrical device 500 available and the use period information for indicating an available time period depending on the payment, from server 400 communicatably connected to terminal device 200 via network 600 such as the Internet. Furthermore, terminal device 200 transfers received key information 461 and use period information to instruction device 300. Instruction device 300 which has received key information 461 and the use period information activates desired electrical device 500 for an available time period included in the use period information. This allows the user to operate electrical device 500 during a limited operating time period depending on the payment to the management company of electrical device 500.

It should be noted that the user payment method is not particularly limited. It is possible to use server 400, i.e. to pay money into the account of the management company of electrical device 500. Alternatively, for example, when terminal device 200 used by the user is terminal device 200 of a prepaid type, a part of the amount paid into terminal device 200 may be used. Furthermore, the available time period for the predetermined money (amount) may be set in advance to any value. The use period information indicating the available time period is stored on server 400, i.e. server storage 460 described below, for example.

Device control system 100 includes terminal device 200, instruction device 300, server 400, and electrical device 500. Server 400 is communicatably connected to terminal device 200 and instruction device 300 via network such as the Internet. Furthermore, terminal device 200 and instruction device 300 are communicatably connected each other. Terminal device 200 and instruction device 300 according to this embodiment can wirelessly communicate with each other.

Hereinafter, components included in device control system 100 will be each described in detail.

### <Terminal Device>

Terminal device 200 is a communication terminal that communicates with instruction device 300 and server 400. A user activates electrical device 500 during a limited time period by operating terminal device 200. Terminal device 200 is, for example, a personal computer, a smart phone, a tablet, etc. Terminal device 200 according to this embodiment is a smart phone.

Terminal device 200 includes terminal communicator 210, terminal controller 220, terminal obtainer 230, and terminal display 240.

Terminal communicator 210 receives, from instruction device 300, identification information 331 for identifying electrical device 500, and transmits, to server 400, identification information 331 and use request information indicating a request for using electrical device 500. Here, the use request information includes at least one of the amount of money and an estimated use time period of electrical device 500.

Furthermore, for example, when key information 461 and the use period information are received from server 400, terminal communicator 210 transmits received key information 461 and use period information to instruction device 300.

Furthermore, for example, terminal communicator 210 transmits, to instruction device 300, instruction information indicating an operation to be performed by electrical device 500. The instruction information means information for giving an instruction on the details to be performed by electrical device 500. For example, when electrical device 500 is video display device 500a such as a television, the instruction information indicates an instruction to turn on/off it or change the channel, etc. Thus, terminal device 200 may serve as a console for electrical device 500.

It should be noted that terminal communicator 210 may transmit the instruction information to server 400.

Terminal communicator 210 is, for example, a communication interface such as a communication path or an adaptor for wireless communication.

Terminal controller 220 is implemented by, for example, a central processing unit (CPU), and a control program executed by the CPU and stored on a memory, not shown in the drawings, such as a read only memory (ROM) or a random access memory (RAM). For example, based on user instructions received by terminal obtainer 230, terminal controller 220 controls various operations of terminal device 200 e.g. transmission of a signal including information such as the instruction information to server 400, instruction device 300, etc. via terminal communicator 210.

Terminal obtainer 230 is a user interface for receiving an input from a user. Terminal obtainer 230 is, for example, a touch panel, a keyboard, etc. For example, a user operates terminal obtainer 230 at a time when the user wants to use electrical device 500, and thereby terminal communicator 210 receives identification information 331 transmitted from instruction device 300 and transfers identification information 331 to server 400. More specifically, when terminal obtainer 230 has received an input from a user, terminal controller 220 receives identification information 331 transmitted from instruction device 300 and transfers identification information 331 to server 400, via terminal communicator 210.

Terminal display 240 is a display device for displaying information to receive an instruction from a user in terminal obtainer 230. Terminal display 240 is, for example, a display.

It should be noted that terminal obtainer 230 and terminal display 240 according to this embodiment are implemented as a touch panel display integrally formed by terminal obtainer 230 and terminal display 240.

### <Instruction Device>

Instruction device 300 is a control device that communicates with terminal device 200 and server 400 and controls electrical device 500. Instruction device 300 controls electrical device 500 based on various information received from terminal device 200. Instruction device 300 according to this embodiment is a distribution panel which performs on/off control of transmission to electrical device 500 of power supplied from external utility power source not shown in the drawings. For example, instruction device 300 is connected to electrical device 500 via a power line. It should be noted that instruction device 300 may be communicatably connected to electrical device 500 by a wireless connection or a wired connection via a communication line.

Instruction device 300 includes instruction communicator 310, instruction controller 320, and instruction storage 330.

Instruction communicator 310 receives key information 461 and the use period information indicating an available time period of electrical device 500, which are transmitted from server 400. Instruction communicator 310 according to this embodiment receives key information 461 and the use period information transmitted from server 400, via terminal device 200. It should be noted that instruction communicator 310 may directly receive key information 461 and the use period information from server 400 without involving terminal device 200.

Instruction communicator 310 is, for example, a communication interface such as a communication path or an adaptor for wireless communication.

Instruction controller 320 controls various operations of instruction device 300.

For example, when key information 461 and the use period information are received via instruction communicator 310, instruction controller 320 causes electrical device 500 to operate for an available time period indicated in the use period information. More specifically, when key information 461 and the use period information are received via instruction communicator 310, instruction controller 320 transmits a signal for causing electrical device 500 to operate, to electrical device 500 for the available time period indicated in the use period information. Electrical device 500 performs an operation based on the received signal.

Furthermore, for example, instruction controller 320 transmits cumulative use period information indicating a total operating time period of electrical device 500, to terminal device 200 via instruction communicator 310. Any timing and any number of times that instruction controller 320 transmits the cumulative use period information to terminal device 200 via instruction communicator 310 are possible. For example, when the cumulative use period information is received via terminal communicator 210, terminal controller 220 causes terminal display 240 to display the total operating time period based on the received cumulative use period information.

Furthermore, for example, instruction controller 320 causes electrical device 500 to operate based on the instruction information for an available time period indicated in the use period information received by instruction communicator 310.

Instruction controller 320 is implemented by, for example, a CPU, and a control program executed by the CPU and stored on instruction storage 330 described below such as ROM, RAM, etc.

Instruction storage 330 is a memory such as ROM, RAM, etc. which stores a control program executed by instruction controller 320. Furthermore, instruction storage 330 according to this embodiment stores identification information 331.

Identification information 331 is information for identifying electrical device 500. Identification information 331 is sufficient as long as electrical device 500 can be identified, and may be associated with each electrical device 500. For example, identification information 331 is a product serial number unique to each electrical device 500, a media access control (MAC) address, etc.

It should be noted that identification information 331 may be stored on electrical device 500, and need not be stored on instruction storage 330. In this case, in response to a request from terminal device 200, instruction device 300 may receive identification information 331 from electrical device 500 and transfer received identification information 331.

Furthermore, instruction device 300 according to this embodiment is shown as a separate component from electrical device 500. However, instruction device 300 may be integrally formed with electrical device 500. For example, instruction device 300 may be included in electrical device 500. Furthermore, it is sufficient that there is at least one electrical device 500 controllable by instruction device 300, and the number of electrical devices is not particularly limited.

Furthermore, instruction device 300 may include a time counter such as a real time clock (RTC) to measure time.

### <Server>

Server 400 is a management server that communicates with terminal device 200 and instruction device 300 and has key information 461. Server 400 is, for example, a personal computer. Server 400 includes server communicator 410, server controller 420, server determiner 430, server obtainer 440, server calculator 450, and server storage 460.

Server communicator 410 communicates with terminal device 200 and instruction device 300. More specifically, server communicator 410 communicates with terminal communicator 210 and instruction communicator 310. More specifically, server communicator 410 receives the use request information and identification information 331 from terminal device 200.

Server communicator 410 is, for example, a communication interface such as a communication path or an adaptor for wireless communication.

Server controller 420 controls various operations of server 400.

For example, when electrical device 500 indicated by identification information 331 is determined by server determiner 430 to be a predetermined electrical device, server controller 420 transmits key information 461 and the use period information via server communicator 410.

Server determiner 430 determines whether electrical device 500 indicated by identification information 331 received via server communicator 410 is the predetermined electrical device. For example, server storage 460 stores electrical device 500 being managed by server 400 as management information 462. Server determiner 430 determines whether electrical device 500 indicated by identification information 331 is included in management information 462. When electrical device 500 indicated by identification information 331 is included in management information 462, server determiner 430 determines electrical device 500 indicated by identification information 331 as the predetermined electrical device.

Furthermore, for example, server controller 420 transmits key information 461 and the use period information to terminal device 200 via server communicator 410.

Server calculator 450 calculates an available time period and a fee for use of electrical device 500 based on the use request information received from terminal device 200 by server communicator 410.

Server obtainer 440 obtains payment information indicating that an amount of money greater than or equal to the fee for use calculated by server calculator 450 has been paid. For example, when a user pays money into the account of the management company of electrical device 500, server obtainer 440 may be an operational device such as a keyboard for an administrator belonging to the management company to input the payment information to server 400. Alternatively, when terminal device 200 used by the user is terminal device 200 of a prepaid type and a part of the amount paid into terminal device 200 is used, server obtainer 440 may be a communication interface to obtain the payment information indicating information on the partially used amount. For example, when server obtainer 440 has obtained the payment information, server controller 420 transmits key information 461 via server communicator 410.

For example, server calculator 450 calculates the fee for use such that a fee per unit time for use of electrical device 500 reduces from a predetermined fee with an increase in the estimated use time period from a predetermined time period.

As described above, server 400 is, for example, a management server used by the management company of electrical device 500. When payment from a user who operates terminal device 200 is confirmed, server 400 determines the available time period of electrical device 500 depending on the payment. Furthermore, server 400 generates key information 461 indicating permission to activate electrical device 500 for the determined available time period, and transmits generated key information 461 and the use period information to terminal device 200.

Server controller 420, server determiner 430, and server calculator 450 are implemented by, for example, a CPU, and a control program executed by the CPU and stored on server storage 460 described below, for example.

It should be noted that the controllers such as server controller 420, server determiner 430, and server calculator 450 may be implemented by, for example, a common hardware component (for example, CPU), or different separate hardware components.

Here, for example, it is assumed that device control system 100 uses two or more electrical devices 500. Furthermore, when electrical devices 500 are used, it is assumed that an excess of total power consumption of electrical devices 500 occurs depending on a power environment to be used. In order to prevent the excess of the total power consumption of electrical devices 500, device control system 100 informs a user that the user is urged to reduce the power consumption when the total power consumption of electrical devices 500 becomes greater than a predetermined power consumption level.

More specifically, when the instruction information indicating the operation for each of different electrical devices 500 is received via server communicator 410, server calculator 450 calculates the total power consumption of currently operating electrical devices 500 based on the received instruction information. Furthermore, when the total power consumption calculated by server calculator 450 is greater than or equal to the predetermined power consumption level, server controller 420 transmits an operation change request for requesting a change to another operation which reduces the power consumption of electrical device 500, to terminal device 200 via server communicator 410. Furthermore, when operation change information indicating that the operation of electrical device 500 has been changed to the operation indicated by the operation change request is received via server communicator 410, server calculator 450 determines the fee per unit time for use of electrical device 500 after the changing of the operation to be lower than that before the changing of the operation, and recalculates the fee for use and the available time period of electrical device 500.

For example, when the total power consumption calculated by server calculator 450 is greater than or equal to the predetermined power consumption level and when electrical device 500 is an air conditioner and it is determined from the instruction information that an air conditioning temperature is set to 26 degrees C., server controller 420 transmits, as the operation change request, a request for reducing the power consumption of electrical device 500 such as changing the air conditioning temperature to 28 degrees C., to terminal device 200 which has transmitted the instruction information. A user operating terminal device 200 confirms a display image displayed on terminal display 240 based on the operation request information, and causes terminal device 200 to transmit the operation change information for setting the air conditioning temperature to 28 degrees C., to instruction device 300 and server 400. Instruction device 300 causes electrical device 500 to change the air conditioning temperature based on the operation change information. Furthermore, server calculator 450 recalculates the fee for use and the available time period based on the operation change information received from terminal device 200 by server communicator 410. The predetermined power consumption level may be set in advance to any value, and is not particularly limited. The predetermined power consumption level is stored in advance on server storage 460.

Server storage 460 is a memory such as ROM, RAM, etc. which stores a control program executed by server controller 420. Server storage 460 also stores key information 461 and management information 462.

Key information 461 is information for giving permission to activate electrical device 500. Key information 461 includes, for example, a password assigned in advance to each of electrical devices 500. This password may be, for example, onetime password. Furthermore, a different password may be assigned to each electrical device 500. Furthermore, for example, key information 461 may be information for making two or more electrical devices 500 available together.

Management information 462 is information for identifying electrical device 500 being managed by server 400. Management information 462 includes, for example, electrical device 500 being managed by server 400 and information that associates electrical device 500 with key information 461. For example, when identification information 331 received via server communicator 410 is determined by server determiner 430 to be information indicating the predetermined electrical device being managed by server 400, server controller 420 transmits corresponding key information 461 based on management information 462 via server communicator 410.

### <Electrical Device>

Electrical device 500 is controlled by instruction device 300 to perform predetermined operations. More specifically, electrical device 500 is available only using key information 461 used by instruction device 300. FIG. 1 illustrates video display device 500a, air conditioning device 500b, and illumination device 500c as electrical devices 500. For example, only when instruction device 300 receives key information 461 and the use period information, electrical device 500 becomes available by being supplied with power. Electrical device 500 has, for example, a communication interface such as a communication path or an adaptor for wireless communication, and is communicatably connected to instruction device 300. Electrical device 500 and instruction device 300 according to this embodiment are connected via communication lines, and thus wired communication is possible.

It should be noted that electrical device 500 is sufficient as long as it is an electrically operated device. For example, a washing machine, a personal computer, etc. are possible.

Furthermore, electrical device 500 that is controlled and energized by instruction device 300 to become available may be, for example, a box that is physically locked with a key and has a door which is open and close by locking and unlocking with the key. When key information 461 and the use period information are received, instruction device 300 may unlock the box for the available time period. Furthermore, for example, when key information 461 and the use period information are received, instruction device 300 may unlock the box for the available time period and energize electrical device 500 in the box for the available time period. Furthermore, for example, the box may include a sensor capable of detecting the number of times that the door opens and closes. In this case, instruction device 300 may change the available time period based on the number of times detected by the sensor. Alternatively, when the sensor detects the predetermined number of times that the door opens and closes, instruction device 300 may make the device, etc. in the box unavailable by locking the box. Thus, electrical device 500 may be not only an electrically operable device such as an appliance, but also a box unlockable by being supplied with power. By disposing a desired device, etc. in the box, a user can use the desired device, etc. in the box for the predetermined time period.

Furthermore, electrical device 500 that is controlled and energized by instruction device 300 to become available may be, for example, an electrical device that is physically locked with a key and has a flap which is open and close by locking and unlocking with the key. When key information 461 and the use period information are received, for example, instruction device 300 may unlock electrical device 500 having a flap such as a washing machine for the available time period and allow the flap to open. Furthermore, for example, electrical device 500 having a flap may include a sensor capable of detecting the number of times that the flap opens and closes. In this case, instruction device 300 may change the available time period based on the number of times detected by the sensor. Alternatively, when the sensor detects the predetermined number of times that the flap opens and closes, instruction device 300 may make electrical device 500 unavailable by locking the flap.

It should be noted that the method for changing the available time period based on the number of times that the door or flap opens and closes may be any method, and is not particularly limited. For example, when the door or flap opens and closes once, instruction device 300, i.e. instruction controller 320, decreases the available time period by any predetermined time period such as 5 minutes.

### [Processing Procedure]

### <Outline>

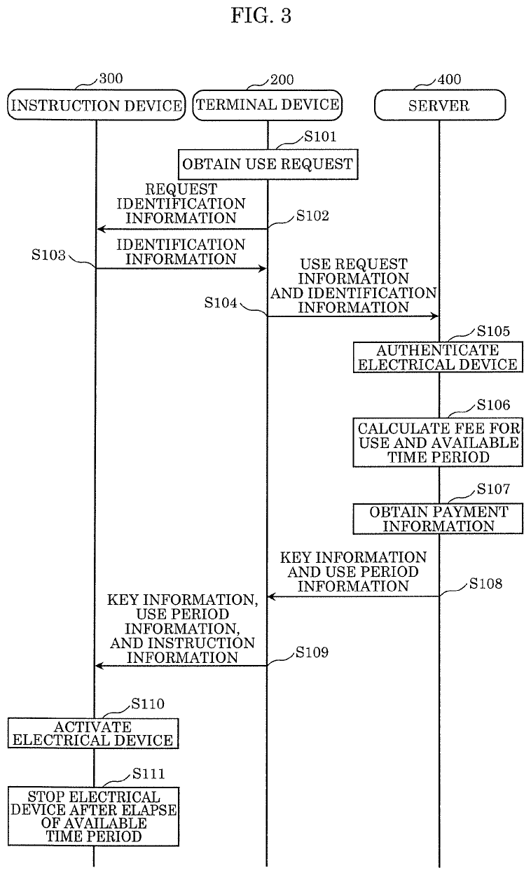

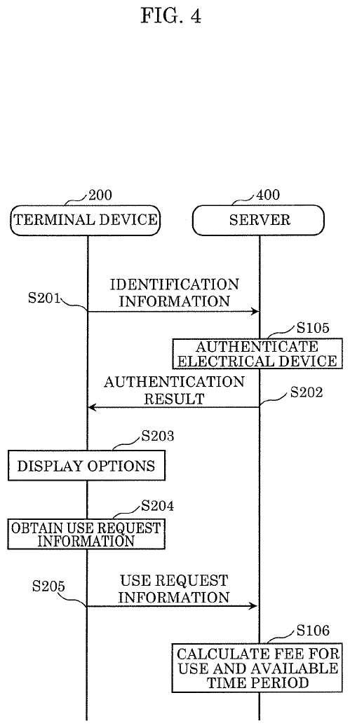

Next, the processing procedure of device control system 100 according to this embodiment will be described with reference to FIGS. 3 and 4.

FIG. 3 is a sequence diagram showing the processing procedure for making electrical device 500 available, which is performed by each device included in device control system 100 according to the embodiment.

First, terminal device 200 receives, from a user, a use request indicating that the user uses electrical device 500 (step S101).

Subsequently, terminal device 200 transmits, to instruction device 300, a signal for requesting identification information 331 of electrical device 500 which the user wants to use (step S102).

Subsequently, instruction device 300 transmits identification information 331 of electrical device 500 to terminal device 200 (step S103).

It should be noted that instruction device 300 may transmit identification information 331 without receiving a request from terminal device 200. In this case, step S102 need not be performed.

After step S103, terminal device 200 transmits, to server 400, received identification information 331 and use request information indicating that the user wants to use electrical device 500 (step S104). Here, for example, the use request information includes at least one of an amount of money and an estimated use time period of electrical device 500.

Subsequently, server 400 authenticates electrical device 500 indicated in received identification information 331 (step S105). In step S105, server 400 determines whether electrical device 500 indicated in identification information 331 is an electrical device included in management information 462.

Subsequently, server 400 calculates a fee for use and an available time period of electrical device 500 based on the received use request information (step S106). For example, when the use request information received at step S105 includes an amount of money, server 400 calculates the available time period from the amount of money included in the use request information at step S106. Server 400 also calculates the amount of money included in the use request information as the fee for use. Furthermore, for example, when the use request information received at step S105 includes an estimated use time period, server 400 calculates the estimated use time period as an available time period at step S106. Server 400 also calculates the fee for use based on the estimated use time period included in the use request information.

Subsequently, server 400 obtains payment information from a user (step S107). In other words, step S107 means that payment from the user has been confirmed.

It should be noted that between step S106 and step S107, server 400 may transmit, to terminal device 200, information indicating the fee for use and the available time period.

Subsequently, server 400 transmits, to terminal device 200, key information 461 associated with electrical device 500 and the use period information indicating the available time period calculated at step S106 (step S108).

Subsequently, terminal device 200 transmits, to instruction device 300, key information 461 received from server 400, the use period information, and instruction information indicating an operation which a user wants electrical device 500 to perform (step S109).

Subsequently, instruction device 300 causes electrical device 500 to operate based on the received instruction information for the available time period indicated in the received use period information (step S110).

Subsequently, instruction device 300 stops the operation of electrical device 500 after the elapse of the available time period indicated in the received use period information (step S111). For example, at step S111, when the available time period indicated in the received use period information has elapsed, instruction device 300 stops the operation of electrical device 500 by stopping supplying power to electrical device 500.

It should be noted that at step S109, terminal device 200 need not transmit the instruction information. In this case, for example, instruction device 300 only energizes electrical device 500. A user may cause electrical device 500 to perform a desired operation by pressing a button, etc. included in electrical device 500.

Furthermore, at step S104, terminal device 200 transmits the use request information and identification information 331. Here, terminal device 200 may transmit, to server 400, the use request information and identification information 331 at a different time.

FIG. 4 is a flow chart showing another exemplary processing procedure for making electrical device 500 available, which is performed by a terminal device and server 400 included in device control system 100 according to the embodiment. In other words, FIG. 4 is another example of steps S104 and S105 shown in FIG. 3. It should be noted that FIG. 4 omits steps S101 to S103 shown in FIG. 3, and steps including and following step S107 shown in FIG. 3.

Subsequent to step S103 shown in FIG. 3, terminal device 200 transmits identification information 331 of electrical device 500 to terminal device 200 (Step S201).

Subsequently, server 400 authenticates electrical device 500 indicated in received identification information 331 (step S105).

Subsequently, server 400 transmits the authentication result to terminal device 200 (step S202). It should be noted that it is assumed here that server 400 determines that electrical device 500 indicated by identification information 331 at step S105 is a predetermined electrical device and transmits, to terminal device 200, information indicating that electrical device 500 is the predetermined electrical device.

Subsequently, terminal device 200 displays an image including options to be selected by a user as a next operation performed by terminal device 200 (step S203). More specifically, at step S203, terminal controller 220 causes terminal display 240 to display the image including the options to be selected by a user as a next operation performed by terminal device 200. Here, the options include, for example, setting of payment to the management company of electrical device 500, input of an estimated use time period of electrical device 500, and input of an amount of money to use electrical device 500. Specific examples of the options will be described below.

Subsequently, terminal device 200 receives an input from a user to obtain the use request information (step S204).

Subsequently, terminal device 200 transmits the use request information obtained at step S204 to server 400 (step S205).

Subsequently, server 400 calculates a fee for use and an available time period of electrical device 500 based on the received use request information (step S106).

### <Use Request Information Transmission Process>

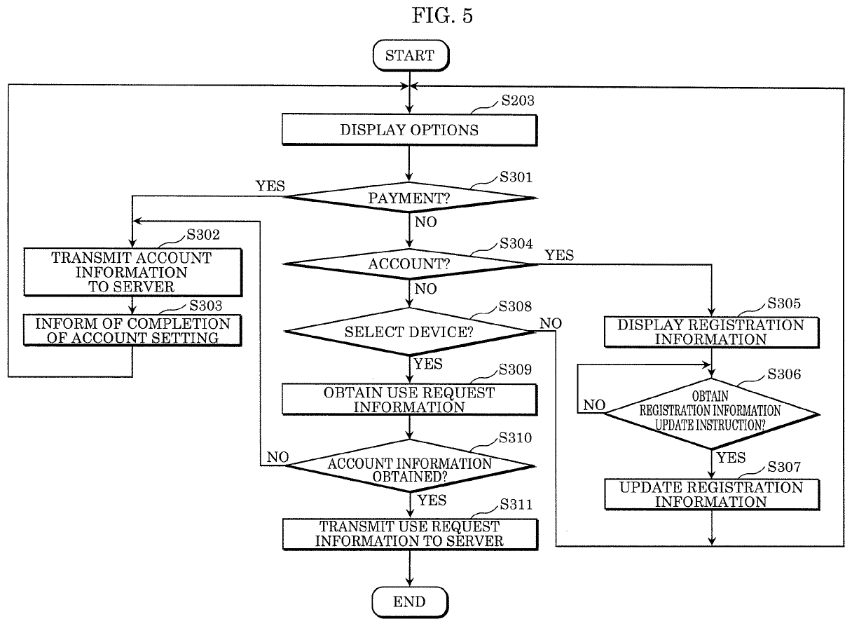

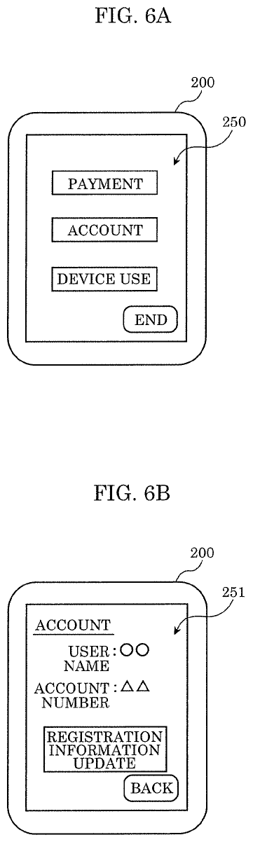

Next, with reference to FIGS. 5, 6A, and 6B, a specific example of a process for transmitting the use request information to server 400 through the operation of terminal device 200 by a user, which is performed at steps S203 to S205 shown in FIG. 4, will be described in detail.

FIG. 5 is a flow chart showing a processing procedure of when terminal device 200 included in device control system 100 according to the embodiment performs the process based on payment from a user.

At step S203 shown in FIGS. 4 and 5, terminal device 200 displays options.

FIG. 6A is a diagram showing the first example of an image displayed on terminal display 240 included in terminal device 200 in use of electrical device 500.

As shown in FIG. 6A, terminal device 200 displays image 250 including, as the options, a portion for receiving an input for a payment process, a portion for displaying a user account, and a portion for displaying an image to be selected by a user as electrical device 500 which the user wants to use. A user uses image 250 displayed on terminal device 200 to determine the next process after step S203.

For example, when the portion for receiving the input for the payment process is pressed (Yes at step S301), terminal device 200 obtains account information. The user inputs his/her account information to terminal device 200, and thereby becomes ready to pay money to the management company of electrical device 500. For example, terminal device 200 receives an account number from the user, and transmits the received account number to server 400 (step S302).

Furthermore, for example, when a response to the account number transmitted to server 400 at step S302 is received from server 400, terminal device 200 informs the user of completion of the account setting (step S303), and the processing returns to step S203. Here, for example, the user may be informed using sound or an image.

Furthermore, for example, when the portion for receiving the input for the payment process is not pressed (No at step S301) and the portion for displaying a user account is pressed (Yes at step S304), terminal device 200 displays registration information such as a user account number (step S305).

FIG. 6B is a diagram showing the second example of an image displayed on terminal display 240 included in terminal device 200 in use of electrical device 500.

As shown in FIG. 6B, for example, when a user already has his/her account, image 251 including a user name, an account number, etc. are displayed as user information at step S305. It should be noted that, for example, when the user has no account, an image for creating an account (not shown) may be displayed.

Subsequently, terminal device 200 determines whether a registration information update instruction indicating an instruction for updating the registered account information, i.e. changing the registered account information, has been obtained (step S306).

When no registration information update instruction is obtained from a user (No at step S306), terminal device 200 stays at step S306, for example. It should be noted that, for example, when “back” button included in image 251 is pressed or when a predetermined time period has elapsed, the processing of terminal device 200 may return to step S203.

On the other hand, when the registration information update instruction is obtained (Yes at step S306), e.g. when the “registration information update” button included in image 251 is pressed, terminal device 200 displays image (not shown) for receiving a user input for changing the registration information, receives from a user an input indicating the change in the registration information, and updates the registration information (step S307), and the processing returns to step S203.

Furthermore, for example, when the portion for displaying the user account is not pressed (No at step S304) and a portion for displaying an image to be selected by a user as electrical device 500 which the user wants to use is pressed (Yes at step S308), terminal device 200 displays a list of electrical devices 500 available to the user. For example, when instruction device 300 can control two or more electrical devices 500 and terminal device 200 receives identification information 331 on two or more electrical devices 500 from instruction device 300, terminal device 200 displays types of electrical devices 500 indicated in identification information 331, e.g. a television, an air conditioner, etc.

Subsequently, terminal device 200 obtains, from a user, the use request information indicating electrical device 500 which the user wants to use, an estimated use time period, an amount of money, etc. (step S309).

Subsequently, terminal device 200 determines whether the user account information has been obtained (step S310). Here, the account information is, for example, the account number obtained at step S302, or the account number already registered in the user account. At step S310, terminal device 200 determines whether the user is ready to pay money to the management company of electrical device 500.

When terminal device 200 determines that no user account information has been obtained (No at step S310), the processing proceeds to step S302.

On the other hand, when terminal device 200 determines that the user account information has been obtained (Yes at step S310), terminal device 200 transmits the use request information to server 400 (step S311).

In this way, when the user is ready to pay money, terminal device 200 can transmit the use request information to server 400.

### <Operation Change Process>

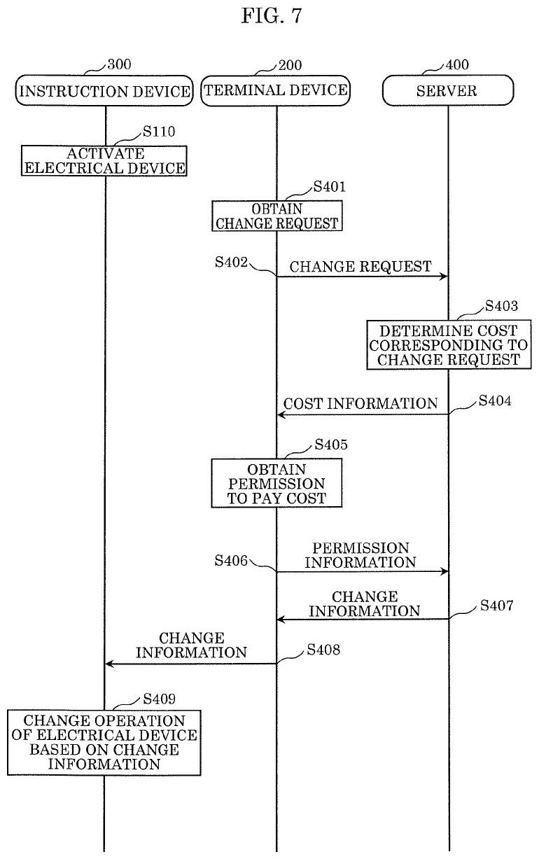

Next, with reference to FIG. 7, a process performed by terminal device 200, instruction device 300, and server 400 when a user wants to change usage conditions of electrical device 500 will be described.

FIG. 7 is a sequence diagram showing a processing procedure for changing usage conditions of electrical device 500, which is performed by each device included in device control system 100 according to the embodiment. It should be noted that FIG. 7 is a sequence diagram illustrating a process following the processes to step S110 shown in FIG. 3.

Instruction device 300 causes electrical device 500 to operate based on the received instruction information for an available time period indicated in the use period information (step S110).

Here, for example, it is assumed that terminal device 200 has received an input for changing the usage conditions of electrical device 500 (step S401). For example, it is assumed that at step S401, terminal device 200 has received an input indicating an instruction to extend the available time period of electrical device 500.

Terminal device 200 transmits to server 400 a change request indicating the input received at step S401 (step S402).

Subsequently, server 400 determines a cost corresponding to the received change request (step S403). At step S403, for example, server calculator 450 calculates, as the cost, an additional usage fee for a desired additional time period included in the change request. Here, the cost is not limited to an amount of money. For example, when electrical device 500 used by a user is video display device 500a, the cost may be exchanged for displaying of an advertisement on video display device 500a for the desired additional time period included in the change request.

Subsequently, server 400 transmits, to terminal device 200, cost information indicating the cost determined at step S403 (step S404).

Subsequently, terminal device 200 informs a user of the details of the cost indicated in the received cost information using an image, sound, etc., and obtains a permission to pay the cost (step S405). At step S405, when the permission to pay the cost has been obtained, terminal device 200 transmits permission information indicating the permission, to server 400 (step S406).

Subsequently, when the permission information is received, server 400 transmits change information indicating an instruction to change the operation of electrical device 500 (step S407). For example, in the case where the cost is money, when payment from a user is confirmed, server 400 performs step S407. Furthermore, for example, in the case where electrical device 500 used by a user is video display device 500a and the cost is exchanged for displaying of an advertisement, the change information may include an image of an advertisement.

Subsequently, terminal device 200 forwards, to terminal device 200, the change information received from server 400 (step S408).

It should be noted that at S407, server 400 may directly transmit the change information to instruction device 300. In this case, terminal device 200 does not perform step S408.

Subsequently, instruction device 300 changes the operation of electrical device 500 based on the received change information (step S409). For example, at step S409, instruction device 300 extends the estimated use time period based on the change information.

### <Power Consumption Reduction Process>

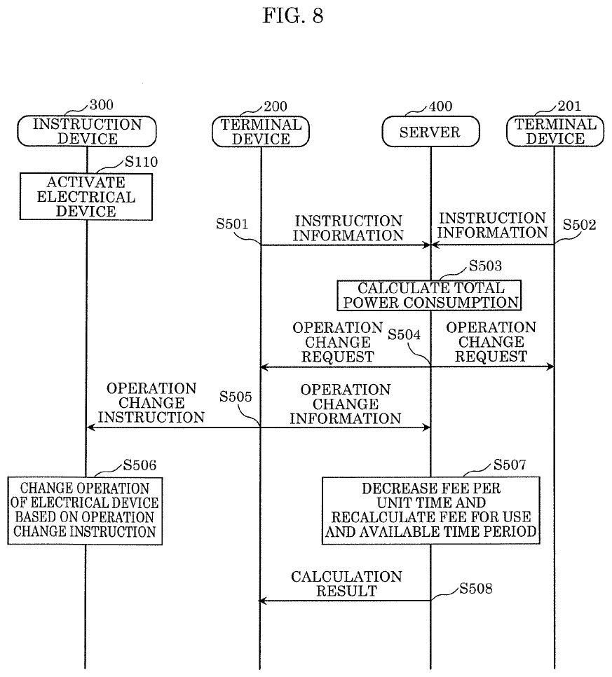

Next, with reference to FIG. 8, a process for reducing the power consumption of each activated electrical device 500 when the management company of electrical device 500 manages two or more electrical devices 500 will be described.

FIG. 8 is a sequence diagram showing a processing procedure for changing the usage conditions to reduce power consumption of electrical device 500, which is performed by each device included in device control system 100 according to the embodiment. It should be noted that FIG. 8 depicts, as terminal device 201, a terminal device used by a user who uses an electrical device different from an electrical device used by another user who uses terminal device 200. Furthermore, FIG. 8 is a sequence diagram illustrating a process following the processes to step S110 shown in FIG. 3.

Instruction device 300 causes electrical device 500 to operate based on the received instruction information for an available time period indicated in the use period information (step S110).

Furthermore, terminal device 200 transmits, to server 400, instruction information indicating the operation being performed by electrical device 500 (step S501).

It should be noted that step S501 may be performed by instruction device 300. In other word, instruction device 300 may transmit the details of the operation of electrical device 500 to server 400.

Furthermore, terminal device 201 transmits, to server 400, the instruction information transmitted to the electrical device used by a user who operates terminal device 201 (step S502).

In this way, server 400 collects the details of operations of one or more electrical devices 500 which are currently operating based on the instruction information.

Server 400 calculates total power consumption of one or more currently operating electrical devices 500 based on the instruction information received from terminal devices 200, 201 (step S503).

Subsequently, when the calculated total power consumption is greater than or equal to the predetermined power consumption, server 400 transmits, to terminal devices 200, 201, an operation change request for requesting a change to an operation in which the power consumption of electrical device 500 is reduced (step S504). It should be noted that the predetermined power consumption may be set to any value, and is not particularly limited.

Terminal devices 200, 201 inform a user of information indicating the received operation change request using an image, sound, etc.

Here, it is assumed that a user of terminal device 200 has accepted the operation change request. Terminal device 200 transmits, to instruction device 300, an instruction to change the operation of electrical device 500 to the operation indicated by the operation change request, and also transmits, to server 400, operation change information indicating that the operation of electrical device 500 has been changed to the operation indicated by operation change request (step S505).

Instruction device 300 changes the operation of electrical device 500 based on the received operation change instruction (step S506).

As shown in step S505 and step S506, more specifically, when the operation change request is received, terminal communicator 210 may transmit, to instruction device 300, an operation change instruction indicating an instruction to change the operation of electrical device 500 to the other operation indicated by the operation change request received. In particular, when the operation change request via terminal communicator 210 is received, terminal controller 220 may transmit, to instruction device 300, the operation change instruction indicating an instruction to change the operation of electrical device 500 to the other operation indicated by the operation change request received. In this case, instruction controller 320 may change the operation of electrical device 500 based on the operation change instruction received via instruction communicator 310.

Furthermore, when the operation change information is received from terminal device 200, server 400 determines the fee per unit time for use of electrical device 500 after the change in operation to be lower than that before the change in operation, and recalculates the fee for use and the available time period of electrical device 500 (step S507).

Subsequently, server 400 transmits, to terminal device 200, the calculation result indicating the fee for use and the available time period recalculated at step S507 (step S508).

It should be noted that when the available time period recalculated at step S507 is extended, terminal device 200 may forward the received calculation result to instruction device 300. In this way, instruction device 300 may extend the available time period of electrical device 500 based on the received calculation result. More specifically, when a calculation result indicating the fee for use and the available time period of electrical device 500 recalculated by server calculator 450 is received, terminal communicator 210 may transmit the calculation result to instruction device 300 when the available time period of electrical device 500 recalculated is extended. In particular, when the calculation result indicating the fee for use and the available time period of electrical device 500 recalculated by server calculator 450 is received via terminal communicator 210, terminal controller 220 may transmit the calculation result to instruction device 300 via terminal communicator 210 when the available time period of electrical device 500 recalculated is extended. In this case, instruction controller 320 may extend the available time period of electrical device 500 based on the calculation result received.

Furthermore, after step S506, instruction device 300 may transmit, to server 400, change information indicating that the operation has been changed. In this way, server 400 can determine whether it is ensured that the operation of electrical device 500 has been changed to the operation indicated by the operation change request. More specifically, when the operation of electrical device 500 is changed, instruction controller 320 may transmit, to server 400 via instruction communicator 310, change information indicating that the operation of electrical device 500 has been changed.

### [Advantageous Effects, Etc.]

As described above, device control system 100 according to the embodiment includes: instruction device 300 that controls operation of electrical device 500 which requires key information 461 to operate; and terminal device 200 that communicates with instruction device 300. Terminal device 200 includes terminal communicator 210 that: receives, from instruction device 300, identification information 331 for identifying electrical device 500; and transmits, to server 400, identification information 331 and use request information indicating a request for using electrical device 500. Instruction device 300 includes: instruction communicator 310 that receives key information 461 and use period information indicating an available time period of electrical device 500 transmitted from server 400; and instruction controller 320 that, when key information 461 and the use period information are received via instruction communicator 310, activates electrical device 500 for the available time period indicated in the use period information.

With this configuration, by using terminal device 200, a user can easily use desired electrical device 500 for a desired time period. Furthermore, by using key information 461, instruction device 300 can ensure and facilitate the control of making only electrical device 500 desired by the user available. Thus, with simple configuration, device control system 100 can activate electrical device 500 for a desired time period.

For example, some of users may be difficult to pay money for electrical device 500 such as an air conditioner, etc. In view of the user's ability to pay, it may also be difficult to make a loan which allows the user to pay money for electrical device 500 after the purchase. In view of this, there is a demand that electrical device 500 is temporarily introduced to a user without a fee and the user is allowed to use electrical device 500 by prepaying the amount of money corresponding to the estimated use time period of electrical device 500. Here, if the user is allowed to use all electrical devices 500 belonging to the user, the electric bill becomes expensive and the financial burden increases. Accordingly, a method for determining usage conditions of electrical device 500 depending on the amount of user payment is conceived. In view of this, it is necessary to ensure that the user payment is associated with the usage conditions of electrical devices 500.

Accordingly, device control system 100 according to the embodiment distributes key information 461 in response to a user request, and thereby makes electrical device 500, which requires key information 461 to operate, available for a predetermined time period (an available time period). With this, for example, the distribution of key information 461 and the setting of the available time period of electrical device 500 can be performed depending on the user payment. Thus, for example, device control system 100 can prevent user abuse of electrical device 500 and make it possible to limitedly operate preregistered electrical device 500 depending on the user payment.

For example, instruction controller 320 transmits cumulative use period information indicating a total operating time period of electrical device 500 to terminal device 200 via instruction communicator 310.

With this configuration, for example, terminal device 200 causes terminal display 240 to display cumulative use period information, and thereby a user can easily know the total use time period of electrical device 500. For example, even when electrical device 500 stops due to unexpected accidents such as power failure, the user can immediately and reliably know the total usage time period until electrical device 500 stops.

Furthermore, for example, device control system 100 further includes server 400. Server 400 includes: server communicator 410 that receives the use request information and identification information 331 from terminal device 200; server determiner 430 that determines whether electrical device 500 indicated by identification information 331 received via server communicator 410 is a predetermined electrical device which is being managed by server 400; and server controller 420 that, when electrical device 500 indicated by identification information 331 is determined to be the predetermined electrical device by server determiner 430, transmits key information 461 and the use period information via server communicator 410.

With this configuration, server 400 can easily determine whether electrical device 500 indicated by identification information 331 is electrical device 500 belonging to the management company of electrical device 500, and appropriately transmit key information 461.

Furthermore, for example, server controller 420 transmits key information 461 and the use period information to terminal device 200 via server communicator 410, and terminal communicator 210 transmits key information 461 and the use period information received from server 400, to instruction device 300.

With this configuration, even when instruction device 300 and server 400 cannot communicate with each other, server 400 can correctly transmit key information 461 to instruction device 300 which has transmitted identification information 331.

Furthermore, for example, the use request information includes at least one of an amount of money and an estimated use time period of electrical device 500. Furthermore, for example, server 400 further includes: server calculator 450 that calculates the available time period and a fee for use of electrical device 500 based on the use request information received from terminal device 200 via server communicator 410; and server obtainer 440 that obtains payment information indicating that an amount of money greater than or equal to the fee for use calculated by server calculator 450 has been paid. Furthermore, for example, when server obtainer 440 has obtained the payment information, server controller 420 transmits key information 461 via server communicator 410.

In other words, the use request information includes an amount of money. Server 400 further includes: server calculator 450 that calculates the available time period based on the use request information received from terminal device 200 by server communicator 410; and server obtainer 440 that obtains payment information indicating that the amount of money has been paid. In this case, when server obtainer 440 has obtained the payment information, server controller 420 transmits the key information and the use period information via server communicator 410.

Alternatively, the use request information includes an estimated use time period of electrical device 500. Server 400 further includes: server calculator 450 that calculates a fee for use of electrical device 500 based on the use request information received from terminal device 200 by server communicator 410; and server obtainer 440 that obtains payment information indicating that an amount of money greater than or equal to the fee for use calculated by server calculator 450 has been paid. In this case, when server obtainer 440 has obtained the payment information, server controller 420 transmits the key information and the use period information via server communicator 410.

With this configuration, only when a user has paid money to the management company of electrical device 500, server 400 can more reliably transmit key information 461. This can more effectively prevent user abuse of electrical device 500.

Furthermore, for example, server calculator 450 calculates the fee for use so that a fee per unit time for use of electrical device 500 is reduced with an increase in the estimated use time period.

With this configuration, the fee per unit time for use of electrical device 500 reduces with an increase in the use time period of electrical device 500, and thus it is possible to enhance the user's use of electrical device 500.

Furthermore, for example, terminal communicator 210 transmits, to instruction device 300, instruction information indicating an operation to be performed by electrical device 500, and instruction controller 320 causes electrical device 500 to operate based on the instruction information for the available time period indicated in the use period information received via instruction communicator 310.

With this configuration, terminal device 200 can be used as a console for giving an instruction on the operation of electrical device 500. This allows a user to easily operate and use electrical device 500 even when electrical device 500 has no dedicated console.

Furthermore, for example, terminal communicator 210 transmits the instruction information for each of electrical devices 500 to server 400. Server communicator 410 receives the instruction information. Server calculator 450 may calculate total power consumption of currently operating ones of electrical devices 500 based on the received instruction information. Furthermore, for example, when the total power consumption calculated by server calculator 450 is greater than or equal to a predetermined power consumption level, server controller 420 may transmit, to terminal device 200 via server communicator 410, an operation change request for requesting a change to an other operation which reduces power consumption of electrical device 500. Furthermore, for example, when operation change information indicating that the operation of electrical device 500 has been changed to the other operation indicated by the operation change request is received via server communicator 410, server calculator 450 further determines the fee per unit time for use of electrical device 500 after the changing of the operation to be lower than that before the changing of the operation, and recalculates the fee for use and the available time period of electrical device 500. It should be noted that device control system 100 may include one terminal device 200, or multiple terminal devices 200. In other words, terminal device 200 which transmits the instruction information may be implemented by one terminal device 200 or multiple terminal devices 200. Furthermore, device control system 100 may include one electrical device 500, or multiple electrical devices 500. In other words, terminal device 200 transmits, to server 400, the instruction information for electrical device 500 to be operated or multiple pieces of instruction information for their respective electrical devices 500 to be operated, for example.

For example, it is assumed that power failure, etc. occurs depending on the environment where electrical devices 500 are disposed, due to an excess of the total power consumption of electrical devices 500. Accordingly, in order to prevent the excess of the total power consumption of electrical devices 500, device control system 100 informs a user that the user is urged to reduce the power consumption when the total power consumption of electrical devices 500 becomes greater than a predetermined consumption level. By this way, server 400 can urge the user to reduce the power consumption of electrical device 500. Furthermore, server calculator 450 determines the fee per unit time for use of electrical device 500 after the change in operation to be lower than that before the change in operation. By this way, server 400 can further urge the user to reduce the power consumption of electrical device 500.

It should be noted that a specific aspect of foregoing device control system 100 may be implemented as a method. In other words, a device control method according to this embodiment is a device control method of controlling operation of electrical device 500 which requires key information 461 to operate, the device control method including: by terminal device 200, receiving, from instruction device 300, identification information 331 for identifying electrical device 500, and transmitting, to server 400, identification information 331 and use request information indicating a request for using electrical device 500; and by instruction device 300, when key information 461 and use period information indicating an available time period of electrical device 500 are received, activating electrical device 500 for the available time period indicated by the use period information received.

Such a method produces the same advantageous effects as device control system 100.

### [Specific Examples for Video Display Device]

Next, with reference to FIGS. 2, 9, and 10, specific examples for the case where electrical device 500 is video display device 500a shown in FIG. 1 will be described in details.

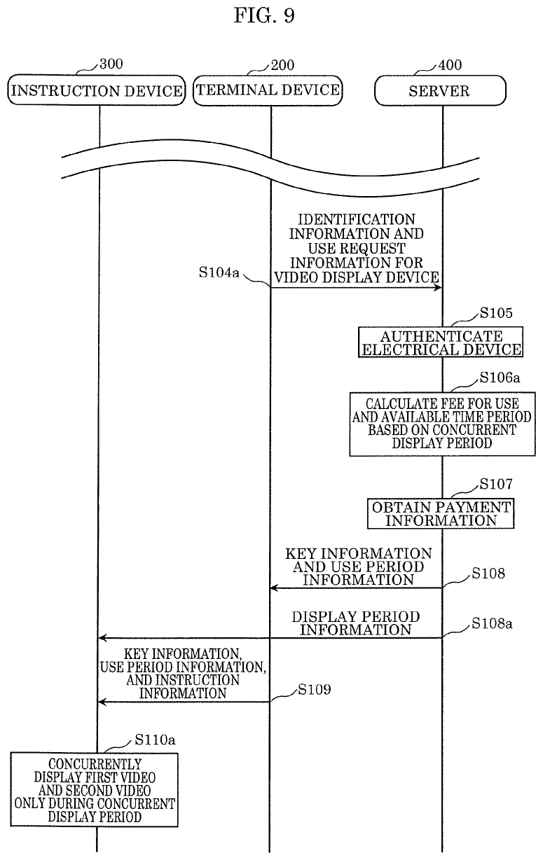

FIG. 9 is a sequence diagram showing, when electrical device 500 is video display device 500a, the first example of the processing procedure for making electrical device 500 available which is performed by each device included in device control system 100 according to the embodiment. It should be noted that FIG. 9 is a sequence diagram illustrating a process following the processes to step S103 shown in FIG. 3.

Terminal device 200 transmits, to server 400, identification information 331 received from instruction device 300 and use request information for video display device 500a indicating that a user wants to use video display device 500a (step S104a).

Subsequently, server 400 authenticates electrical device 500 indicated in received identification information 331 (step S105).

Subsequently, server 400 calculates a fee for use and an available time period of video display device 500a based on the received use request information and a predetermined concurrent display period for which video display device 500a concurrently displays the second video with displaying of the first video (step S106a). More specifically, at step S106a, server calculator 450 shown in FIG. 2 calculates the fee for use and the available time period of video display device 500a based on the predetermined concurrent display period for which video display device 500a concurrently displays the second video with displaying of the first video. Here, the first video means a video such as a TV program caused by a user to display on video display device 500a, and the second video means an advertisement video caused by the management company of video display device 500a to purposely display on video display device 500a. The predetermined concurrent display period may be set in advance to any value, and is not particularly limited. For example, when the predetermined concurrent display period is 5 minutes, server 400, i.e. server controller 420, performs calculation such as 5-minute extension of the available time period or reduction of the fee for use.

Subsequently, server 400 obtains payment information from the user (step S107).

Subsequently, server 400 transmits, to terminal device 200, key information 461 associated with video display device 500a and the use period information indicating the available time period calculated at step S106 (step S108).

Server 400 also transmits, to instruction device 300, display period information indicating a time period for which the second video is displayed (step S108a).

Subsequently, terminal device 200 transmits, to instruction device 300, key information 461 received from server 400, the use period information, and instruction information indicating an operation which a user wants video display device 500a to perform (step S109).

Subsequently, when video display device 500a is activated, instruction device 300 causes video display device 500a to operate such that the first video and the second video are concurrently displayed for the concurrent display period indicated in the received display period information (step S110a). More specifically, at step S110a, when the display period information indicating the predetermined concurrent display period is received via instruction communicator 310, instruction controller 320 shown in FIG. 2 causes video display device 500a to concurrently display the first video and the second video for the predetermined concurrent display period indicated in the display period information received from server 400.

As described above, when electrical device 500 is video display device 500a, server calculator 450 may calculate the fee for use and the available time period of video display device 500a based on the predetermined concurrent display period for which video display device 500a concurrently displays the second video with displaying of the first video. Furthermore, when the display period information indicating the predetermined concurrent display period is received via instruction communicator 310, instruction controller 320 may cause video display device 500a to concurrently display the first video and the second video for the predetermined concurrent display period indicated in the display period information received from server 400.

It should be noted that video display device 500a need not concurrently display the first video and the second video. For example, video display device 500a may display the first video after the second video is displayed. In other words, in the case where electrical device 500 is video display device 500a, for example, when display period information indicating a predetermined display period for which video display device 500a displays the second video in displaying of the first video is received via instruction communicator 310, instruction controller 320 causes video display device 500a to display the second video for the predetermined display period indicated by the display period information received from server 400.

With this configuration, instruction device 300 can cause video display device 500a to display the second video such as an advertisement. Accordingly, for example, by extending the available time period instead of displaying the second video, the second video can be displayed so as to bring benefits to a user, and thus it is possible to enhance the user's use of device control system 100.

It should be noted that when instruction device 300 or video display device 500a has no information on the second video, server 400 may transmit the information on the second video to instruction device 300 at step S108a.

Furthermore, server 400 may transmit, to terminal device 200, information for confirming whether the second video is displayed. For example, when this information is received, terminal device 200 may display an image indicating this information. In other words, terminal device 200 may display an image for confirming whether the second video is displayed. For example, a user operates terminal device 200 to select whether the second video is displayed, and causes terminal device 200 to transmit the selection result to server 400. When the received selection result is displaying of the second video, server 400 may calculate the fee for use and the available time period of video display device 500a based on the predetermined display period for which video display device 500a displays the second video in displaying of the first video.

Furthermore, when electrical device 500 is video display device 500a, instruction device 300 may display the second video for the predetermined concurrent display period.

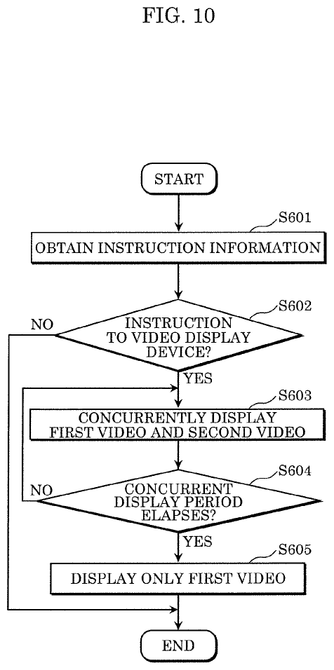

FIG. 10 is a flow chart showing, when electrical device 500 is video display device 500a, the second example of a processing procedure for activating video display device 500a which is performed by an instruction device included in device control system 100 according to the embodiment. It should be noted that FIG. 10 is a flow chart illustrating a process performed by instruction device 300 after step S109 shown in FIG. 3.

It is assumed that instruction device 300 has been obtained the instruction information from terminal device 200 (step S601).

Instruction device 300 determines whether the instruction information received at step S601 is an instruction to video display device 500a (step S602).

When it is determined that the instruction information received at step S601 is not the instruction to video display device 500a (No at step S602), instruction device 300 performs the process based on the instruction information.

On the other hand, when it is determined that the instruction information received at step S601 is the instruction to video display device 500a (Yes at step S602), instruction device 300 causes video display device 500a to concurrently display the predetermined second video when video display device 500a is caused to display the first video (step S603).

Subsequently, instruction device 300 determines whether a time period for which video display device 500a is caused to concurrently display the first video and the second video is longer than the predetermined concurrent display period (step S604). More specifically, at step S604, instruction controller 320 shown in FIG. 2 determines whether the total display period for which video display device 500a is caused to display the first video is longer than the predetermined display period.

When it is determined that the time period for which video display device 500a is caused to concurrently display the first video and the second video is shorter than the predetermined concurrent display period (No at step S604) and video display device 500a is caused to display the first video, instruction device 300 causes video display device 500a to concurrently display the predetermined second video. More specifically, when the total display period for which video display device 500a is caused to display the first video is shorter than the predetermined display period, instruction controller 320 shown in FIG. 2 further causes video display device 500a to concurrently display the second video with displaying of the first video. It should be noted that the predetermined display period may be set to any value, and is not particularly limited.

On the other hand, when it is determined that the time period for which video display device 500a is caused to concurrently display the first video and the second video is longer than the predetermined concurrent display period (Yes at step S604), instruction device 300 causes video display device 500a to display only the first video without displaying the second video.

As described above, in the case where electrical device 500 is video display device 500a, when the total display period for which video display device 500a is caused to display the first video is shorter than the predetermined display period, instruction controller 320 may further cause video display device 500a to concurrently display the second video with displaying of the first video.

With this configuration, instruction device 300 can cause video display device 500a to display the second video such as an advertisement and stop displaying the second video depending on the use time period. Accordingly, when the use time period of video display device 500a is increased, a user can view the first video in a larger form without displaying the second video, and thus it is possible to enhance the user's use of video display device 500a.

### Other Variations

Hereinbefore, a device control system, etc. according to the embodiment has been described, but the present disclosure is not limited to the embodiment described above.

For example, elements of a controller such as the controller included in each of the server, the instruction device, and the terminal device included in the device control system may be configured in one or more electronic circuits. The one or more electronic circuits may be each a general-purpose circuit or a dedicated circuit. The one or more electronic circuits may include, for example, a semiconductor device, an integrated circuit (IC), or a large scale integration (LSI). The IC or LSI may be integrated into a single chip or multiple chips. Due to a difference in the degree of integration, the electronic circuit referred here to as an IC or LSI may be referred to as a system LSI, very large scale integration (VLSI), or ultra large scale integration (ULSI). Furthermore, a field programmable gate array (FPGA) which programmable after manufacturing of the LSI can be used for the same purposes.

Furthermore, these general and specific aspects may be implemented using a system, a device, a method, an integrated circuit, or a computer program. Alternatively, these may be implemented using a non-transitory computer-readable recording medium such as an optical disk, HDD, or semiconductor memory storing the computer program. Furthermore, these may be implemented using any combination of systems, devices, methods, integrated circuits, computer programs, or recording media.

Furthermore, in the above embodiment, the terminal device and the instruction device can wirelessly communicate with each other, but the communication method between the terminal device and the instruction device is not particularly limited. For example, the wireless communication between the terminal device and the instruction device may be performed in accordance with a predetermined wireless communication standard such as Bluetooth (registered trademark), Wi-Fi (registered trademark), or ZigBee (registered trademark). Alternately, the terminal device and the instruction device may communicate by wire. In this case, the terminal communicator in the terminal device and the instruction communicator in the instruction device may each include a communication adaptor, etc. to connect a cable for communicating with each other by wire. Furthermore, like the instruction device and the terminal device, the instruction device and the electrical device may be communicatably connected each other by wire or wirelessly.

Furthermore, in the above embodiment, the instruction device and the electrical device are separated, but may be integrally formed. For example, the instruction device may be located in the housing of the electrical device, or the electrical device may perform the steps to be performed by the instruction device.

Embodiments arrived at by a person skilled in the art making various modifications to the embodiment as well as embodiments realized by arbitrarily combining structural components and functions in the embodiment which do not depart from the essence of the present disclosure are included in the present disclosure.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A device control system, comprising:
an instruction device that controls operation of an electrical device which requires key information to operate; and
a terminal device that communicates with the instruction device, wherein:
the terminal device includes a terminal communicator that: receives, from the instruction device, identification information for identifying the electrical device; and transmits, to a server, the identification information and use request information indicating a request for using the electrical device, and
the instruction device includes:
an instruction communicator that receives, from the server, the key information and use period information indicating an available time period of the electrical device; and
an instruction controller that, when the key information and the use period information are received via the instruction communicator, activates the electrical device for the available time period indicated in the use period information.

2. The device control system according to claim 1, wherein
the instruction controller transmits cumulative use period information indicating a total operating time period of the electrical device to the terminal device via the instruction communicator.

3. The device control system according to claim 1, further comprising:
the server, wherein
the server includes:
a server communicator that receives the use request information and the identification information from the terminal device;
a server determiner that determines whether the electrical device indicated by the identification information received via the server communicator is a predetermined electrical device which is being managed by the server; and
a server controller that, when the electrical device indicated by the identification information is determined to be the predetermined electrical device by the server determiner, transmits the key information and the use period information via the server communicator.

4. The device control system according to claim 3, wherein
the server controller transmits the key information and the use period information to the terminal device via the server communicator, and
the terminal communicator transmits the key information and the use period information received from the server, to the instruction device.

5. The device control system according to claim 3, wherein
the use request information includes an amount of money,
the server further includes:
a server calculator that calculates the available time period based on the use request information received from the terminal device by the server communicator; and
a server obtainer that obtains payment information indicating that the amount of money has been paid, and
when the server obtainer has obtained the payment information, the server controller transmits the key information and the use period information via the server communicator.

6. The device control system according to claim 3, wherein
the use request information includes an estimated use time period of the electrical device,
the server further includes:
a server calculator that calculates a fee for use of the electrical device based on the use request information received from the terminal device by the server communicator; and
a server obtainer that obtains payment information indicating that an amount of money greater than or equal to the fee for use calculated by the server calculator has been paid, and
when the server obtainer has obtained the payment information, the server controller transmits the key information and the use period information via the server communicator.

7. The device control system according to claim 5, wherein
the server calculator calculates the fee for use so that a fee per unit time for use of the electrical device is reduced with an increase in the estimated use time period.

8. The device control system according to claim 5, wherein
the terminal communicator transmits, to the instruction device, instruction information indicating an operation to be performed by the electrical device, and
the instruction controller causes the electrical device to operate based on the instruction information for the available time period indicated in the use period information received via the instruction communicator.

9. The device control system according to claim 8, wherein
the terminal communicator transmits the instruction information to the server,
the server communicator receives the instruction information for each of electrical devices which is the electrical device,
the server calculator calculates total power consumption of currently operating ones of the electrical devices based on the instruction information received,
when the total power consumption calculated by the server calculator is greater than or equal to a predetermined power consumption level, the server controller transmits, to the terminal device via the server communicator, an operation change request for requesting a change to an other operation which reduces power consumption of the electrical device, and
when operation change information indicating that the operation of the electrical device has been changed to the other operation indicated by the operation change request is received via the server communicator, the server calculator further determines the fee per unit time for use of the electrical device after the changing of the operation to be lower than that before the changing of the operation, and recalculates the fee for use and the available time period of the electrical device.

10. The device control system according to claim 9, wherein
when a calculation result indicating the fee for use and the available time period of the electrical device recalculated by the server calculator is received, the terminal communicator transmits the calculation result to the instruction device when the available time period of the electrical device recalculated is extended, and
the instruction controller extends the available time period of the electrical device based on the calculation result received.

11. The device control system according to claim 9, wherein
when the operation change request is received, the terminal communicator transmits, to the instruction device, an operation change instruction indicating an instruction to change the operation of the electrical device to the other operation indicated by the operation change request received, and
the instruction controller changes the operation of the electrical device based on the operation change instruction received via the instruction communicator.

12. The device control system according to claim 11, wherein
when the operation of the electrical device is changed, the instruction controller transmits, to the server via the instruction communicator, change information indicating that the operation of the electrical device has been changed.

13. The device control system according to claim 5, wherein
the electrical device is a video display device, and
when display period information indicating a predetermined display period for which the video display device displays a second video in displaying of a first video is received via the instruction communicator, the instruction controller causes the video display device to display the second video for the predetermined display period indicated by the display period information received from the server.

14. The device control system according to claim 2, wherein
the electrical device is a video display device,
when a total display period for which the video display device is caused to display a first video is shorter than a predetermined display period, the instruction controller further causes the video display device to concurrently display a second video with displaying of the first video.

15. A device control method of controlling operation of an electrical device requires key information to operate, the device control method comprising:
by a terminal device, receiving, from an instruction device, identification information for identifying the electrical device, and transmitting, to a server, the identification information and use request information indicating a request for using the electrical device; and
by the instruction device, when the key information and use period information indicating an available time period of the electrical device are received, activating the electrical device for the available time period indicated by the use period information received.
